(19) United States
(12) Patent Application Publication
(10) Pub. No.: US 2004/0124237 A1
(43) Pub. Date: Jul. 1, 2004

(54) Stock prod

(75) Inventors: Robert M. Bros, Savage, MN (US); Kirk W. Wolfgram, Rochester, MN (US); Peter B. Madson, Minneapolis, MN (US)

Correspondence Address: MOORE, HANSEN & SUMNER, 2900 WELLS FARGO CENTER, 90 SOUTH SEVENTH STREET, MINNEAPOLIS, MN, 55402, US

(73) Assignee: Miller Manufacturing Company, Inc.

(21) Appl. No.: 10/335,994

(22) Filed: Dec. 31, 2002

(51) Int. Cl. B68B 11/00

(52) U.S. Cl. 231/7

(57) ABSTRACT

An electrical discharge stock prod having a circuit that prolongs battery life by monitoring power input and modifying the prod discharge characteristics. The circuit allows the prod to deliver a consistent voltage level to discharge electrodes, even though the power sources may vary. Preferably, the circuit is operated by a micro-controller. Additionally, by virtue of an improved transformer configuration (which lowers the voltage potential between the primary and secondary cores) and strategically placed polypropylene (which reduces carbon arcing) and increased isolation between primary and secondary windings within the transformer, safety of the prod is substantially enhanced. Preferably, the voltage to the discharge electrodes of the prod can be infinitely adjusted within a predetermined range of voltages, energies, and/or pulse rates to allow the prod to be effectively used on subjects having different physical parameters. Moreover, the prod is provided with a multi-function actuator that is configured to provide the prod with two types of cues; an audible cue, and a combined audible and electrical discharge cue, respectively. The prod includes a visual indicator that lets the operator know, at a glance, if the power supply has sufficient energy to operate the prod. And, the prod includes a removable power unit that includes a base, which enables the prod to be free standing when not in use.

### FIELD OF THE INVENTION

This invention relates generally to animal controllers. More specifically, this invention pertains to a prod that controls animals with discharges of electrical energy.

### BACKGROUND OF THE INVENTION

Devices that provide an electric shock to control behavior or movement of animals are well known. These devices, known as stock or cattle prods, are available in a variety of shapes and sizes and can be characterized in that they are able to control animals using high voltage electrical discharges. Generally, stock prods are hand held devices that comprise a housing that contains a power source, circuitry used to generate high voltage, and a pair of high voltage electrodes. The stock prod's power source is typically a dry-cell battery that is connected to an input of the circuitry used to generate the high voltage, with the high voltage generated by a step up transformer and/or a capacitor multiplier circuit. The high voltage output generated by the circuitry is typically connected to a pair of electrodes, which extend away from the exterior of the housing. Preferably, the electrodes are spaced apart from each other by a distance that is sufficient to prevent discharge therebetween. In use, the prod is activated to generate high voltage at the electrodes and the tips of the electrodes are brought into contact with, or in close proximity to, the skin of an animal. As the tips of the electrodes near or touch the animal's skin, the prod discharges leaving the animal with a gentle reminder that it should move or otherwise modify its behavior.

Present stock prods are designed to deliver each discharge as a steady or constant stream of high voltage oscillations or pulses having a predetermined intensity and duration. For example, a discharge may have an intensity of 10,000 volts at a frequency of 2,000 oscillations or pulses per second. It is important to note that the amount of energy expended with each discharge is directly related to battery life. For example, a prod having four C-cell batteries might be able to produce two hours of discharges before the prod loses its effectiveness, whereas a prod having six D-cell batteries might be able to produce three or more hours of discharges before the prod loses its effectiveness. It should be apparent, then, that with provision of additional and/or larger batteries the number of discharges that a prod is able to produce will increase accordingly and the life of the prod will be extended. The drawback with this approach, however, is that extra and/or larger batteries add weight and size to the prod and it eventually becomes too heavy and bulky to operate comfortably for extended periods of time. Alternatively, modifying the output of the prod's discharge can extend the battery life of a prod. There are several ways to do this.

One way is by reducing the duration of each oscillation or pulse. Another way is by lowering the voltage potential that is generated between the tips of the electrodes. In either case, the shock intensity felt by the animal is also reduced. As one may expect, the major drawback to employing such methods is that the increased battery life comes at the expense of operational effectiveness. This could be potentially life threatening, particularly when the operator is unable to administer an effective shock to a particularly large and/or agitated animal, or when an animal's skin is covered with a thick coat of hair.

Regardless of the particular way in which the battery life of a prod is extended, each time the prod is used, the batteries become weaker and the shock intensity diminishes. Eventually, there will be a point where the prod will no longer operate as intended. This is to be expected. The problem is that the battery life of the prod cannot be accurately predicted by merely observing the prod, and an operator has no way of knowing if the battery is capable of generating an hour's worth of discharges or is on the verge of failure. More often than not, the prod will suddenly go dead without any warning. This can be particularly dangerous, especially if the operator is in the midst of a herding operation involving scores of animals. There are several ways in which to prevent the occurrence of such a sudden and potentially catastrophic event.

One way is to periodically replace the batteries of the power source. This is very effective, but it can become quite costly if the batteries are frequently replaced, and it can be wasteful because perfectly good batteries may be thrown away and end up in a landfill. Moreover, it is not always possible to determine if the new batteries are themselves defective or substandard. That is, the batteries could be defective and fail prematurely. Another way to lessen the chance of having a sudden prod failure is to informally test the prod by creating a spark gap between the tips of the electrodes and observing the size of the high voltage arc and accompanying noise that is generated. The problem with this approach is that the inferences drawn from observing the spark are subjective. Moreover, the spark may be masked by bright daylight, accentuated by shadows, or skewed by variable atmospheric conditions such as high humidity, and the observer may overestimate or underestimate the operational capability and condition of the prod and it's battery life.

In a related matter, the above-mentioned stock prods are designed to operate at a given supply voltage, which may be based on the number of batteries used or based on a pre-engineered battery pack. So, for example, a prod may be designed to operate at six volts, nine volts, or in the case of a battery pack, fractional voltages such as seven and one-half volts. In either case, the stock prod's circuit is designed to draw a given amount of current for one particular supply voltage, resulting in a given battery life and given shock intensity. It is important to note that variations in the supply voltage and/or supply impedance can lead to variations in the supply current and variations in the discharge produced at the output end of the prod, which can affect the shock intensity and/or battery life of the prod. Such variations can be caused by changes in battery temperature, the configuration or size designation of the battery, and battery construction. Variability also exists between similarly sized batteries having different manufacturers.

The high voltage potential in present stock prods can be generated by several methods. One method is by using a step-up transformer, which typically comprises a primary (input) winding and a single secondary (output) winding, and has a core that is allowed to float (i.e., not connected to anything in an electrical sense). A drawback to such an arrangement is that electric fields and small amounts of leakage current can cause the core to be charged to an undesirable voltage potential that can lead to transformer failure. In an alternative configuration, the core may be connected to ground in the circuit, typically one of the secondary winding connections. A drawback with this arrangement is, relative to the grounded core, the non-grounded end of the secondary winding becomes charged to a voltage that is equivalent to the output of the prod, which can be around ten thousand volts or higher. This alternative configuration with the grounded core requires that the transformer be constructed with additional space between the grounded core and non-grounded end of the secondary winding to reduce electric fields that would otherwise lead to transformer failure. As will be appreciated, this can result in a larger stock prod housing.

The high voltage potential in present stock prods can also be generated using a capacitor multiplier circuit. Such circuits can be designed in several ways. A common circuit design uses a step-up transformer to drive the capacitor multiplier circuit where the transformer provides an increase in voltage over the supply voltage and the capacitor multiplier circuit steps up the transformer's output voltage to a high voltage potential. Although the transformer's voltage is lower than the high voltage potential, the transformer in this design may also suffer from the same electric field and leakage current as mentioned above. Alternatively, the circuit design may use transistors to drive the circuit. Unfortunately, the problem with such an arrangement is that without the transformer to provide an increase over the supply voltage, the multiplier circuit requires many more stages resulting in a design that is large and expensive. For this reason, this design is not common in the industry.

A common problem with the aforementioned high voltage generating configurations is that the high voltage can circumvent isolation between the various components and, under certain conditions, present a potential hazard to the operator. For instance, the operator may inadvertently become part of the electrical pathway when grabbing onto and holding a prod housing that is covered with condensation, or by accidentally touching an exposed metallic fastener that is in electrical contact with the power supply or primary circuit of the transformer of the prod, thus electrically connecting the user to the stock prod's power supply or primary circuit. In such not altogether uncommon conditions, should one of the electrode tips be brought into contact with an animal, current can flow out one of the high voltage electrodes, down through the animal, through the soil, up through the operator and back into the prod through the moisture or metallic fastener, and from the transformer's primary winding to secondary winding either through direction connection in the circuit or by arcing from primary winding to secondary winding, shocking the operator in the process. For this reason, some present stock prod enclosures try to provide the user with a layer of insulation to keep the user from becoming electrically connected to the power supply or primary circuit of the transformer.

Initially, electric stock prods were only able to produce one discharge level. However, it soon became apparent that one discharge level was not applicable to all animals. The problem was that some animals might be unaffected by the discharge, while other animals might find the shock intensity very intense. As a result, some of the present stock prods are now provided with a switch to change the shock intensity between two different discharge intensity levels or modes, high and low. Other stock prods are provided with interchangeable circuits or electrical generating components that provide predetermined levels of discharge intensity levels that are geared to the particular animal to be controlled. A drawback with these attempts to control the level of discharge intensity is that they are all preset by design and not adjustable, and the prod is unable to operate at an optimal level for a particular animal.

In addition to the high voltage, some stock prods are provided with an audible sound in an effort to control the animal more humanely. As one may imagine, this combination of a high voltage discharge and an audible sound may consume a relatively large amount of power. In an attempt to reduce such power consumption, some prods are provided with a second switch that can be used turn the high voltage off and conserve battery life. Typically, this second switch is located inside the battery compartment of the housing and is relatively difficult to access. This energy saving, high voltage cutout switch also allows the operator to control animals whose behavior has been modified to respond to the audible sound. However, the problem with this type of prod is that it does not give an operator the option of quickly reactivating the high voltage should a bull or other animal decide to charge.

Existing stock prod housings are manufactured using a variety of plastic materials to support the electrodes. Depending on the distance between the electrodes and the voltage differential therebetween, arcing may occur, and this often results in a layer of carbon being deposited across the housing surface. This carbon can cause the stock prod to short-out and stop providing a shock to an animal. One solution to this problem is to increase the space between the electrodes. Another solution to this problem is to reduce the voltage. The problem with these solutions is that they either increase size or reduce effectiveness and do not address the cause of carbon tracking, allowing the problem to reoccur.

There is a need for an electric prod that is able to extend battery life, while maintaining its effectiveness of operation. There is also a need for an electric prod that is less prone to accidental user shock, and transformer failure. There is yet another need for a stock prod that is able to maintain a predetermined output in the presence of different power supplies. There is also a need for a prod whose output intensity may be adjusted to a particular situation or a prod whose output self-adjusts to the situation. There is yet another need for a prod whose operational status is readily observable. There is still another need for prod that is able to provide two levels of animal control cues while the prod is in operation. And there is a need for a prod whose electrodes are less prone to short-circuiting.

### SUMMARY OF THE INVENTION

Briefly, the present invention comprises an electric stock prod of the type that controls or modifies animal behavior through the use of multiple control cues, such as audible sounds and electrical discharges. The prod comprises a power module (or motor) having an input section, an output section, and a multi-functional control circuit. The input section of the power module (or motor) is operatively connected to a suitable power source and the output section of the power module is operatively connected to a pair of discharge electrodes. The power module is provided with a protective shell, which is positioned and secured within a prod housing. The power source may comprise one or more batteries, a battery pack, a fuel cell, or even a self-contained modular power unit, for example, and be positioned and secured within the prod housing or releasably attached to thereto, as the case may be. It will be appreciated that the output of the aforementioned power sources will vary in terms of operational voltage and impedance, and for that reason the prod of the present invention is provided with circuitry that is able to monitor the power source and control the output so that the prod can ultimately provide a consistent shock intensity. The circuitry also has the ability to assess the condition of the power source and transmit this information to the operator. A feature of the circuitry is that it is able to conserve power source life and still administer an effective electrical discharge to an animal. The intensity level of the electrical discharge can be further adjusted to take into account factors inherent to the animal being controlled, and/or external factors such as weather. Preferably, the prod is provided with a two-step trigger switch that is able to provide two control cues (an audio cue, and an electrical discharge cue) which are used to condition an animal and which also conserve energy. High voltage potentials are achieved through the use of a step-up transformer that is configured so that the potential for accidentally shocking the operator is greatly reduced.

More specifically, the stock prod of the present invention provides longer power source life by modifying the discharge of the prod without diminishing its effectiveness. This is achieved by forming each discharge into a series of short pulse trains instead of one long continuous pulse train or oscillations, and its operation may be described thusly: a short pulse train, then a pause with no pulses, then another short pulse train, then another pause with no pulses, and-so-on. Preferably, each of the shorter pulse trains has the same energy level per pulse and the same pulse rate as the longer continuous output. However, this can change depending on how the circuitry is programmed or configured. The benefits of having such a discharge are twofold. First, the prod is able to deliver a discharge that is as effective as a long pulse train. And second, by providing periods of acquiescence between the short pulse trains, power source life is prolonged. It will be appreciated that the parameters of operation such as energy level, pulse rate, periods of acquiescence between the pulses, etc. are values that may be programmed or otherwise incorporated into the circuitry design.

The step-up transformer of the present invention differs from prior art stock prods in that it has two secondary windings rather than one secondary winding. With this configuration, the two secondary windings are connected to each other in series, with one end of each winding connected as a center tap, which is connected to the transformer core. By using two secondary windings in series the voltage potential between the transformer's secondary winding can be halved, relative to the core. Thus, instead of having a ten thousand volt differential between a single secondary winding and the core, there are two voltage differentials of plus and minus five thousand volts between each of the two secondary windings and the core. Note that the voltage differential between those ends of the secondary windings not connected to the center tap would be equal to the output potential of the prod, in this example, ten thousand volts. This configuration allows the distance between the core and the windings to be reduced, resulting in a smaller, lighter, and less expensive transformer.

Another feature of the step-up transformer is that it also has an isolation value that has a higher value than the output voltage. By increasing the primary to secondary isolation such that the isolation is greater than the output voltage of the prod, the output voltage is prevented from jumping from the primary to the secondary winding to complete the circuit through an operator. This virtually eliminates any shock through an operator and the circuitry even if the operator is directly or indirectly in contact with the power source.

The circuitry of the prod performs several functions, one of which is to monitor the output of the power source. In operation, the circuitry compares the output of the power source with one or more predetermined values. Then depending on the degree of difference between the monitored and predetermined values, the circuitry will activate an indicator. For example, if the circuitry detects a level of supply current in the normal operating range, it will provide a signal to the operator of the prod. If the circuitry detects a level of supply current that is slightly below the normal operating range, but still able to produce an effective output, it will provide a different signal to the operator of the prod. And, if the circuitry detects a level of supply current that causes the output falls below a minimum threshold, it will provide yet another different signal. Thus the operator of the prod will be able to determine, in advance of use, if the power source needs to be immediately replaced or needs to be replaced in the near future. Preferably, the indicators are visually discernable when activated. However, it will be appreciated that they may produce sounds when activated, for example, pre-recorded messages, or tones.

Another function performed by the circuitry is to control the output or shock intensity. This is achieved using two different methods each independent from each another. In the first method, control is achieved by measuring the supply voltage of the power source to determine operational values. It will be appreciated that the operational values determine the output parameters of the output, such as voltage, number of pulses per second, and duration of pulse trains and duration between pulse trains. For example, four C-cell batteries combined to generate an output voltage of six volts will have a set of operational parameters different than the operational parameters for six C-cell batteries combined to generate an output voltage of nine volts. In each case, the combination of operational parameters and supply voltage will result in the same output parameters such as voltage, number of pulses per second, etc.

The second method to control the output or shock intensity is by measuring the supply current and comparing it to operational values that may be predetermined or generated according to the supply voltage. If there are differences between the measured and predetermined values, the output level of the power source is adjusted to bring it into accord with the predetermined value. For example, the circuit draws a given amount of current. The circuitry is designed so that it is able to measure this current draw and compare it to a predetermined value, say one amp, and adjust the output accordingly. Note that the operational values may be designed into, pre-programmed, or generated on a real-time basis by the circuitry as it measures the voltage value. As will be appreciated, this allows the prod to able to accommodate variations in power source impedance due to changes in temperature, changes in power source capacity, or with differences in impedances that occur in different brands of power sources, for example; without any appreciable change in performance. It also allows the prod to operate with different power sources having a range of operational voltages such as one or more batteries, a battery pack, or even a modular power unit having its own protective housing.

Additionally, the prod of the present invention is provided with a separate output adjuster with which to further vary the output level of the discharge. This gives an operator more control over the intensity of the shock that is delivered to an animal. Preferably, the variable output is achieved by providing the circuitry of the prod with a potentiometer. Thus, the prod is able to provide a range of shock intensity levels.

Advantageously, the stock prod is configured to be able to provide two distinct modes of operation. In the first mode, the stock prod will emit an audio cue. In the second mode, the stock prod will emit an audio cue and administer an electrical discharge. Thus, an operator can administer two types of control cues to an animal. In use, the operator of a prod will initially actuate the first mode of operation and then later progress to the second mode of operation so that an animal will receive an innocuous audio cue, and if necessary, an electrical discharge cue. As will be appreciated, actuating the two control cues may be accomplished in a number of ways and with a number of different switching arrangements, such as two separate switches or a single toggle switch. Preferably, however, the two modes of operation are controlled through one multi-step switch. And preferably, this multi-step switch is in the form of a two-step trigger switch. In order to activate the “audio only” first mode, the operator need only partially depress the trigger by a predetermined amount of movement. Note that in this mode, there will be no electrical discharge and this conserves battery life. In order to activate the second mode, which includes both audio and electrical cues, the trigger has to be depressed by a second, predetermined amount of movement.

Another feature of the present invention is that a portion of the power module housing between the discharge electrodes is provided with material that resists carbon tracking that would otherwise result in a carbon track and premature failure. Preferably, the material is polypropylene, and preferably the polypropylene is formed as a unitary structure such as an end cap, which receives and positions the discharge electrodes in a predetermined relation. It will be appreciated, however, that the polypropylene may take the form of a protective layer that is applied or attached to an end cap in a conventional manner.

Accordingly, an object of the present invention is to provide an electrically powered hand-held stock prod for controlling the movement and/or behavior of animals.

Another object of the invention is to increase the operational life of a prod without changing the effectiveness of its electrical discharge or shock intensity.

It is another object of the present invention to reduce the potential for user shock.

Yet another object of the invention is to facilitate determination of the operational status of a stock prod.

A feature of the present invention is that the input is monitored to control the output.

Another feature of the invention is that the prod may be powered by a variety of different sources having a range of voltage potentials.

Yet another feature of the present invention is that the operator may vary the shock intensity within a range of predetermined values.

Yet another feature of the present invention is that the shock intensity may be varied within a range of predetermined values by the control circuitry.

Still another feature of the invention is that the operational status of a prod may be visually ascertained.

Still another feature of the present invention is the ability to provide different levels and types of sensory cues for controlling the movement or behavior of animals.

An advantage of the present invention is that a prod is able to operate effectively using different power sources.

Another advantage of the invention is that the output may be tailored to a particular situation.

Still another advantage of the present invention is that a user can tell, at a glance, the operational status of a prod.

These and other objects, features and advantages of the present invention will become apparent from the following detailed description thereof taken in conjunction with the accompanying drawing, wherein like reference numerals designate like elements throughout the several views.

### BRIEF DESCRIPTION OF THE DRAWINGS

FIG. 1 is a side plan view of a preferred embodiment of a stock prod;

FIG. 2 is a top plan view of the stock prod of FIG. 1;

FIG. 3 is a partial cross-sectional view of the stock prod of FIG. 1 taken along lines 3-3;

FIG. 4 is a cross-sectional view of the stock prod of FIG. 2 taken along lines 4-4;

FIG. 5 is a partial, exploded perspective view of a preferred housing and housing cover of a power supply for the stock prod of FIG. 1;

FIG. 6 is an isometric view of a preferred power module for the stock prod of FIG. 1;

FIG. 7 is an exploded view of the power module of FIG. 5;

FIG. 8 is a schematic representation of a preferred circuit used in the preferred stock prod of FIG. 1;

FIG. 9 is a partial top plan view of the circuit board illustrating the location of some of the components of the power module of FIG. 5; and,

FIG. 10 is a partial, isometric view of a preferred transformer used in the stock prod of FIG. 1.

### DESCRIPTION OF THE PREFERRED EMBODIMENT

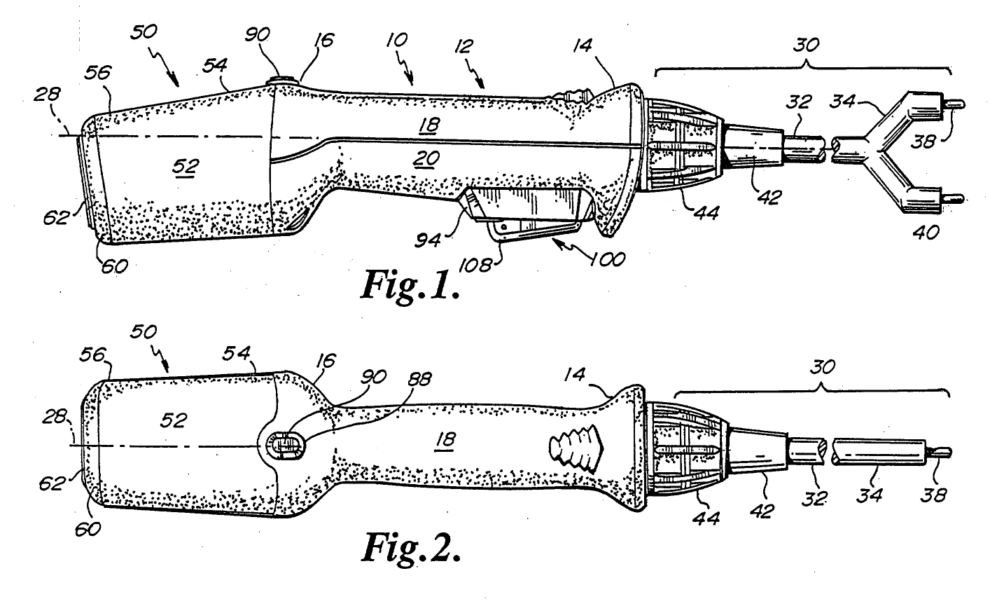

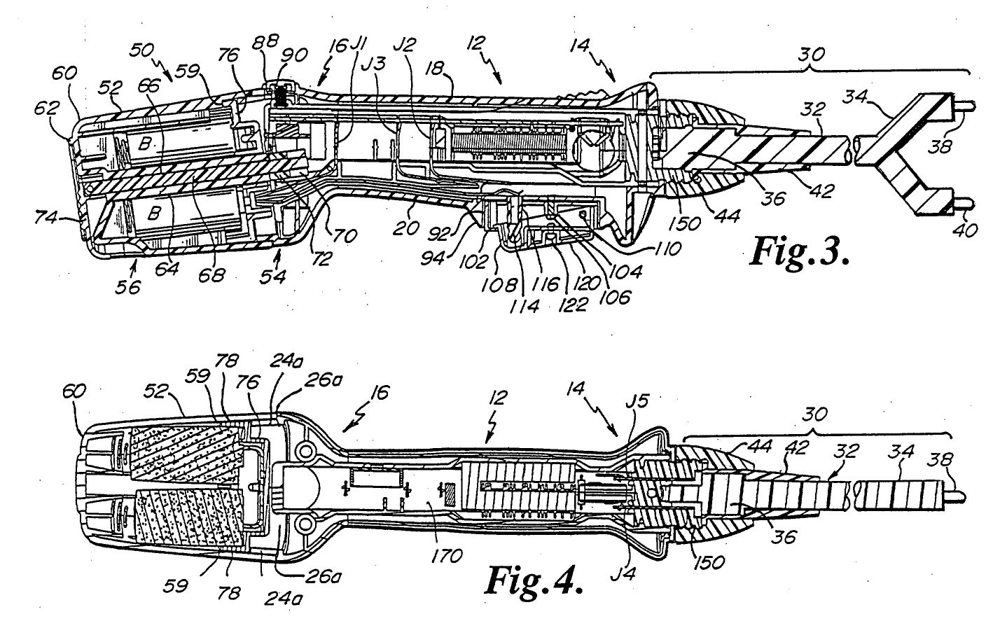

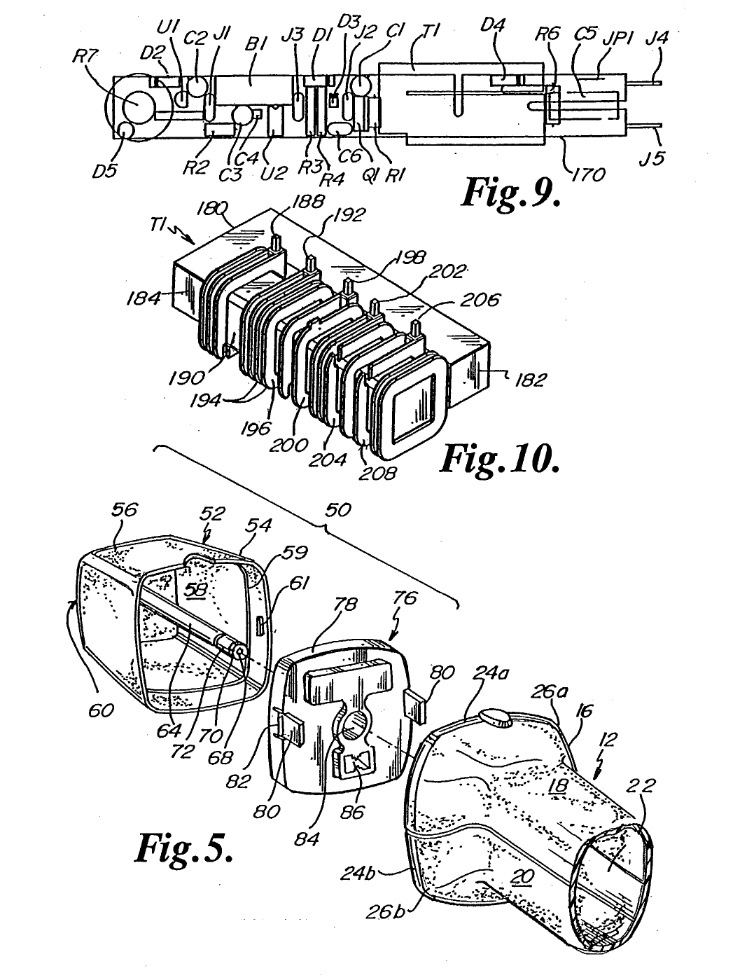

Referring to FIG. 1, a preferred embodiment of a stock prod 10 is depicted. As can be seen, the stock prod 10 comprises an elongated body 12 having a first end 14 and a second end 16. The first end 14 of the body 12 is operatively connected to a conventionally configured shaft 30 of the type having an attachment end 32 and a discharge end 34, with the attachment end 32 includes a base 36 (see FIG. 3) and the discharge end 34 including electrodes 38, 40. The shaft 30 is operatively connected to the first end 14 of the body 12 by a ferrule 42 and a nut 44. The second end 16 of the body 12 is operatively connected to a power supply 50 that comprises a housing 52 having a first end 54, a second end 56 and a cavity 58 (see FIGS. 3-5). As can be seen, the first end 54 of the power supply 50 is operatively connected to the second end 16 of the body 12 in a manner that will be discussed later in greater detail. For ease of fabrication, body 12 is formed as housing members 18, 20 which are removably connectable to each other in a confronting relation and which form an interior space 22 (see FIG. 5) that is configured to retain a power module 130 (see, for example, FIGS. 3, 6 and 7). As can be seen in FIG. 2, housing member 18 includes an aperture 88 that is configured to retain a protective lens 90, which is positioned over a changeable indicator on the power module 130 (FIGS. 3, 6, and 7). As will be appreciated lens 90 may be clear or tinted as desired.

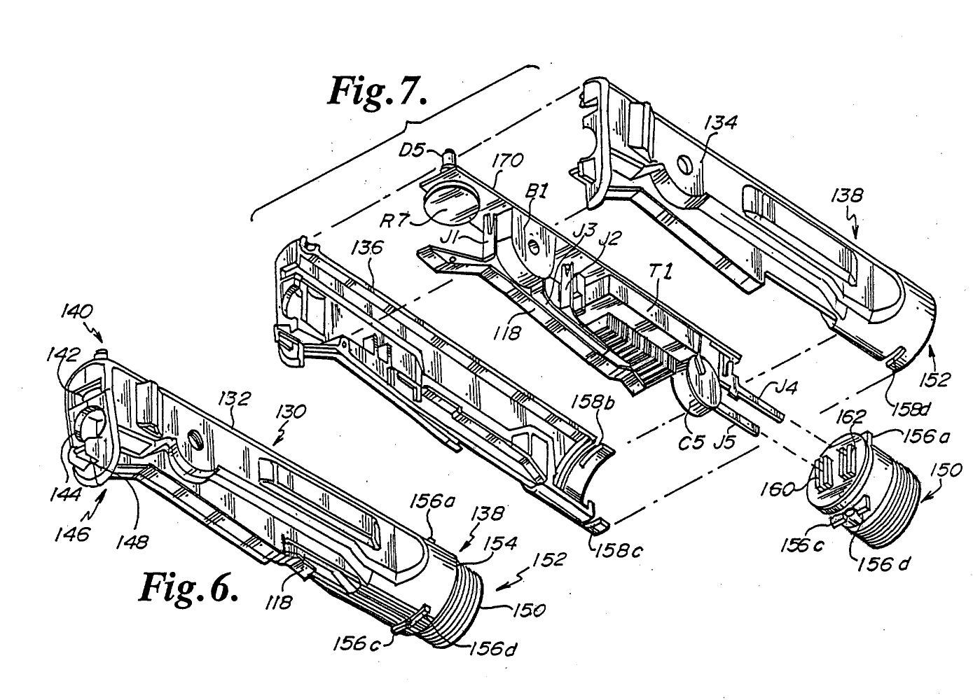

Referring to FIG. 3, the second housing member 20 includes a recess 92 and a peripheral wall 94 that are configured to receive a trigger assembly 100. The trigger assembly 100 comprises a trigger housing 102 and a switch (or trigger) 108 that is pivotally connected to the housing 102 by a pivot pin 110. The trigger assembly 100 is provided with a biasing element (not shown) that urges the switch 108 towards an off or non-engagement position. The assembly 100 also comprises a plunger 114 that is operatively connected to the switch 108 and which may be moved thereby into the interior 22 (shown in FIG. 5) of the body 12 through apertures 116, 98 of the housing 102 and body 12, respectively, so that it may engage an electrical contact 118 (see FIG. 6). Preferably, the trigger assembly 100 is attached to the housing member 20 by a fastener 106 that passes through apertures 96 and 104 of the body 12 and the housing 102, respectively. The trigger assembly 100 also comprises a trigger lock 120 that is movably connected to the trigger switch 108 by a connecting member such as a pin fastener 122. In order to lock the trigger switch 108 the trigger lock 120, which is normally aligned with the trigger switch 108, is rotated so that it is misaligned relative to the trigger switch 108. When the trigger lock 120 is rotated in such a manner, the trigger lock is 120 is positioned so that it will contact the walls of the trigger housing 100 and/or the peripheral wall 94 of the housing member 20. When this occurs, the trigger switch 108 and attached plunger 114 are prevented from moving the contact 118 (see FIG. 6) so that it completes an electrical circuit.

Turning to FIGS. 3 and 4, the shaft 30 is operatively connected to the first end 14 of the body 12 by a ferrule 42 that engages the base 36 of the shaft 30, and a nut 44 that frictionally and compressively engages the ferrule 42. Preferably, the nut 44 is threaded so that it may engage an end cap that extends beyond the first end 14 of the body 12. Note that the electrical conduits of the shaft have been omitted since they do not form a part of this invention.

Referring to FIGS. 3 and 4, and the second end 56 of the housing 52, note that the exterior surface of the base 60 is designed and configured so that it may support the stock prod 10 in a freestanding relation. As can be seen, the exterior surface of the base 60 is substantially planar. Preferably, the base 60 is provided with a stand-off or rib 62 that further positions the stock prod 10 and which provides clearance for a latch 74 that secures the housing 52 to the body 12.

Referring to FIGS. 3 and 4, and the first end 54 of the housing 52, note that the cavity 58, which retainingly receives batteries B, may be closed off by a housing cover 76. The cover 76 comprises a circumferential wall 78 that is configured to engage an internally formed ledge 59 in the power supply housing 52. The cover also comprises resiliently mounted tabs 80 having outwardly extending projections 82 that engage inwardly facing recesses 61 (see FIG. 5) formed in the interior surface of the housing 52. In an unstressed state, the tabs 80 are arranged so that the outwardly facing projections 82 are in position to engage the recesses 61 in the housing 52. To disengage or attach the cover 76 to the housing 52, the tabs 80 and their projections 82 are biased towards each other in a pinching action. Once the pinching action is discontinued, the tabs 80 are free to resume their unstressed state. The cover also comprises an aperture 84 (see FIG. 5) that is configured to accept a central shaft 64 that extends from the second end of the housing 52. As can be seen, the central shaft 64 extends through the cavity 58 of the housing 52 and through the aperture 84 (see FIG. 5) of the cover 76, but also partially though an aperture in the body 12 (see also FIG. 6). The central shaft 64 includes a through hole 66 that is configured to slidingly accept a rod 68. One end of the rod 68 is threaded and provided with a nut 70. The nut 70 is used to retain a deformable member 72 on the rod 68 so that it is positioned between the top of the end of the central shaft 64 and the nut 70. The other end of the rod 68 is provided with a pivotly mounted latch 74. The latch 74 is configured so that when it is aligned with the rod 68 the deformable member 72 is in an unstressed state, and when the latch 74 is pivoted so that it is transverse to the rod 68 the deformable member 72 is compressed and expands radially relative to the central shaft 64 and the aperture in the body 12 (see also, FIG. 6). Note that when the deformable member 72 is in its expanded state, it is larger than the aperture of the body 12, and withdrawal of the central shaft 64 therefrom is prevented.

Referring to FIG. 5, the juxtaposition of a power supply housing 52, a housing cover 76 and a body 12 can be seen. Assembly is a follows. A cover 76 is positioned over the first end 54 of the housing 52. Note that batteries have been omitted from the cavity 58 of the housing 52 to facilitate a better understanding of the figure. The tabs 80 are then moved towards each other in a pinching action and the aperture 84 of the cover 76 is aligned with the central shaft 64. The cover 76 is then slid over the central shaft 64 until the circumferential wall 78 engages the ledge 59 of the housing. Since the depth of the circumferential wall 78 of the cover 76 is less than the depth of the ledge 59 of the housing 52, the cover 76 will be recessed relative the edge of the first end 54. The tabs 80 are then released and the projections 82 are allowed to engage the recesses 61 of the housing. To attach the power supply housing 52 to the body 12, the first end 54 of the housing is brought into alignment with the second end 16 of the body 12. The housing 52 and the body 12 are then brought together. As the housing 52 and the body 12 are brought together, offset skirts 24a, 24b guide their movements until the housing 52 contacts shoulders 26a, 26b of the body. As this occurs, the deformable member 72 of the central shaft 64 protrudes through an attachment aperture in the body (see FIG. 6). After the housing 52 and the body 12 have been joined together, the latch 74 (see FIG. 3) is pivoted so that it is transverse to the rod 68. This causes the deformable member 72 to expand and prevent the central shaft 64 from being withdrawn from the engagement with the aperture in the body. It will be appreciated that the cover 76 need not be present for the power supply housing 52 to be connected to the body 12, and that there may be occasions where such a connection will be necessary or desirable.

Referring to FIG. 6, the body 12 (as shown in FIG. 1) is configured to retain a power module 130 comprising a shell 132 having opposing helves 134, 136 (see FIG. 7). The shell 132 has a first end 138 and a second end 140. The second end 140 comprises an aperture 144 that is configured to admit the nut 70 and the deformable member 72 of the central shaft 64 that extends from the base 60 of the power supply housing 52. The second end 140 also comprises a second aperture 142 that is configured to permit manipulation of an output adjustment member. The second end 140 also comprises an input section 146 which operatively connects to the power supply 50 through the electrical interface 86 (see FIG. 5) of the housing cover 76 of the power supply housing 52. As will be seen, the input section 146 distributes power to several areas of the power module 130. Continuing on, the first end 138 comprises a threaded end cap 150 that forms a portion of the output section 152, which partially extends from the shell 132.

Referring to FIG. 7, the shell halves 134, 136 have been separated to reveal internal components of the power module 130. As can be seen, the shell halves 134, 136 form an aperture 154 at the first end 138 that receives the end cap 150. The end cap 150 comprises a plurality of tabs 156(a-d) that are configured to be received in slots 158(a-d) in the shell halves 134, 136 during assembly of the shell 132. The end cap 150 includes two apertures 160, 162 that are configured to receive and retain connectors J5, J4, respectively, that conduct electricity to the shaft 30 (see also, FIG. 4). The end cap 150 is fabricated from material that resists carbon tracking. Preferably, the material comprises polypropylene. It is understood, however that other material having similar characteristics may also be used. It is also understood that the end cap need not be fabricated as a unitary structure, and that carbon tracking resistant material may be applied to the end cap in a conventional manner using known techniques and technologies. The internal components of the power module 130 are carried on a printed circuit board 170 whose circuitry will be discussed in greater detail below.

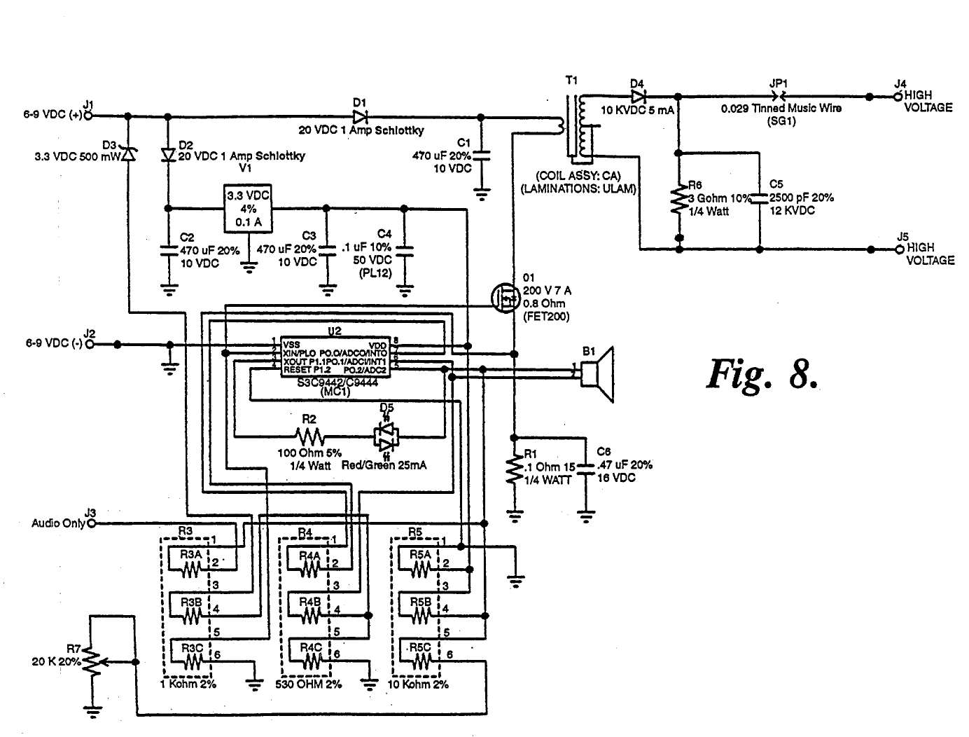

Referring to FIGS. 8 and 9, a preferred circuit diagram of a stock prod in accordance with the present invention is shown. The power supply circuit is powered by a suitable direct current power supply, which may be take the form of four to seven batteries providing six to nine volts DC. The circuit is connected to the power supply by through connectors J1 and J2, where J1 and J2 are positive and negative, respectively.

Power from the power supply is connected to three sections of the circuit in FIG. 8. First, power is connected to the voltage sense circuit comprised of zener diode D3 used to create an offset voltage and resistor R3B and resistor R4C configured in what is commonly referred to as a voltage divider. Voltage at the common point of resistor R3B/R4C is connected to the control circuit through resistor R4B provided as a high impedance between the voltage divider and the control circuit. The voltage sense circuit provides the control circuit with measurable voltage reflective of the power supply voltage.

Second, power is connected to transformer T1 through diode D1 and capacitor C1. Transformer T1 is used to generate high voltage and is turned on and off by a transistor Q1 which is connected to the control circuit. When transformer T1 is turned on (on-time), current flows through the primary winding storing energy in the transformer's core. When transformer T1 is turned off (off-time), energy in the core is coupled to the secondary winding of Transformer T1 creating a high voltage pulse. The on-time and off-time are critical to both the prod's shock intensity and power supply life and are an intricate part of the timing circuit covered later. Current provided to transformer T1 is provided through diode D1, which is used to prevent current flow should the power supply be connected with the incorrect polarity. Current provided to transformer T1 is also provided through capacitor C1, which is used as a filter to provide a more constant current flow from the power supply.

Third, power is connected to the power supply for the control circuit and is comprises a voltage regulator U1, capacitors C2, C3, and C4 and diode D2. Voltage regulator U1 provides a constant voltage for the control circuit and serves as a reference voltage. Capacitors C2, C3, and C4 all provide filtering for electrical noise. Diode D2 is used to prevent current flow from the power supply to the control circuit should the power supply be connected with the incorrect polarity. The control circuit consists of a single part, micro-controller U2. Micro-controller U2 performs all measurements, provides all timing functions, determines all operating values, and controls functions of the stock prod. When power is applied to the circuit shown in FIG. 8, micro-controller U2 starts executing it's program and measures the voltage from the voltage sense circuit comprised of Diode D3 and Resistors R3B, R4C, and R4B through an internal A/D converter connected to pin 6 of Micro-controller U2. The voltage measured by micro-controller U2 at pin 6 is directly related to the supply voltage. The program executed in micro-controller U2 compares the measured voltage to predetermined values to determine the voltage of the power source and sets additional operating parameters based on the operating voltage. The step of setting operating parameters for variation in supply voltage allows the stock prod's shock intensity and power supply life to be kept constant regardless of supply voltage.

Once the voltage of the power supply is determined and micro-controller U2 determines the operating parameters for given supply voltage, micro-controller U2 executes program code to determine the position of the trigger (or switch, see 108 of FIG. 3). The trigger is provided with three positions. The first position is off with connector J3 connected to the negative supply contact, connector J2. When the trigger is partially pressed, power is applied to the circuit through connector J2 and J1. As the trigger is further pressed to the third position, connector J3 is disconnected from ground (Connector J2). Micro-controller U2 measures the voltage on connector J3 through resistor R3A by means of another A/D converter connected to pin 5. R3A is provided to allow micro-controller pin 5 to operate as an output while connector J3 is connected to ground. If the voltage measured by micro-controller U2 at pin 5 is connected to ground, the program changes pins 5 and 6 to outputs to drive an annunciator (preferably a buzzer) B1. The program remains in a loop measuring the position of the trigger based on the voltage at pin 5 and toggles outputs from pins 3, 5, and 6 to create an audio sound from the annunciator (buzzer) B1 and to create a signal from an indicator of an indicator circuit (wherein the indicator circuit preferably comprises a light emitting diode (LED) D5 and current limiting resistor R2). When the trigger is fully pressed, the voltage at pin 5 rises above ground allowing micro-controller U2 to measure the increase in voltage causing the program to move to the section of program code used to generate high voltage at the prod's output connectors J4 and J5. This three-stage trigger allows the user to activate the prod in either audio only or in high voltage modes without the use of a second switch located in an inconvenient location.

Before turning the high voltage on, micro-controller U2 executes a section of program to determine the output level according to where the user sets the position of an output adjuster (preferably a potentiometer) R7. The potentiometer R7 is connected to ground and in series with resistors R5C and R5B where resistor R5B becomes the upper leg of a voltage divider. Resistors R7 and R5C become the adjustable lower leg of the voltage divider, and common point of the voltage divider (R5B and R5C) is measured by micro-controller U2 through the A/D converter connected to pin 5. Based on the voltage measured by micro-controller U2 at pin 5, parameters are determined for the output of the prod. As long as the high voltage is on, micro-controller U2 will loop back to this section of the program, determine position of potentiometer R7, and adjust the parameters for the output based on the position of potentiometer R7.

After micro-controller U2 has executed the section of program to determine the user's desired output level according to the position of the output adjuster R7, micro-controller U2 provides a signal to transistor Q1 turning current on to the primary winding of transformer T1. The gate of transistor Q1 is also connected through resistor R3C to ground to bleed off any gate charge on transistor Q1. When transistor Q1 is turned on and current flows from the positive supply source connected to connector J1, through diode D1, through the primary winding of transformer T1, through transistor Q1, and through resistor R1 to ground connected to connector J2. Resistor R1 is provided in the lower leg of the current path to provide a voltage level that changes relative to ground with the amount of current through the primary winding of transformer T1. Resistor R1 is also provided in parallel with capacitor C6 provided for noise suppression. As current through transformer T1 increases during the current pulse, the voltage across resistor R1 increases. The voltage across resistor R1 is measured by micro-controller U2 through another A/D converter located within micro-controller U2 at pin 7 through Resistor R4A. Resistor R4A is provided just as in impedance between micro-controller U2 and the rest of the circuit for purposes of noise rejection. After determining the current through the primary winding of transformer T1 by means of the voltage across resistor R1, micro-controller U2 compares the current to operating parameters to determine if the current is within limits. If the parameters are not within limits, micro-controller U2 adjusts the on-time duration to move the current back within limits. This allows the prod to compensate for changes in power supply due to factors such as aging or temperature (ie. old and/or cold batteries).

As micro-controller U2 determines the supply current by measuring the voltage across resistor R1, it also determines if the current can be maintained within limits, maintained out of limits, or inadequate for the prod to deliver an effective output. If the current can be maintained within limits, micro-controller U2 sets outputs at pins 3 and 5 to turn the indicator on to a predetermined color (ie. turning the LED D5 on green) to provide a signal to the user that the power source is acceptable. If the current can be maintained but not within limits, micro-controller U2 sets outputs at pins 3 and 5 to turn the indicator on to a second predetermined color (ie. turning the LED D5 on yellow) to provide a signal to the user that the power source is weak. If the current is determined to be inadequate to provide an effective output, micro-controller U2 sets outputs at pins 3 and 5 to turn the indicator on to a third predetermined color (ie. turning the LED D5 on red) to provide a signal to the user that the power source is unacceptable. This provides the user with immediate feedback regarding the condition of the power source.

Micro-controller U2 continues executing it's program turning transformer T1 on and off by transistor Q1, while determining the supply current by measuring the voltage across resistor R1, determining the user's desired output according to the position of output adjuster (potentiometer) R7, controlling the type of signal that the indicator displays to the user through diode D5 according to the condition of the power source, and adjusting operating parameters, limits, and variables to maintain a constant output. After continuing operation for two seconds, micro-controller U2 tests pin 4 to determine if it is connected to ground, or if the ground has been removed at the factory where resistor R5A connected between micro-controller pin 4 and Vdd pulls pin 4 above ground. If micro-controller U2 determines pin 4 is connected to ground, the program continues in the same loop described above. If micro-controller U2 determines pin 4 is no longer connected to ground, transistor Q1 is turned off and held off until the user releases the trigger and reapplies power causing micro-controller U2 to restart at the beginning of it's program. This determination of the condition of micro-controller U2 pin 4 allows the program to operate in more than one mode; for example, when continuous operation is desired, or when operation is stopped after a predetermined period of time (for example, two seconds).

While micro-controller U2 turns transformer T1 on and off, off-times are periodically extended creating pulse trains and periods with no output. The shock intensity felt during the pulse train is the same as if no off-time had been extended. Although no shock is felt during the time of the extended off-time, the prod is as effective during the pulse train. This extended off-time reduces the average current draw from the power source, which results in longer power supply life

As the current is turned on and off through the primary winding of transformer T1, high voltage pulses are developed on the secondary winding. These pulses are rectified through diode D4 and stored in capacitor C5 until the voltage in capacitor C5 is high enough to break down spark gap JP1. Capacitor C5 is provided with a resistor R6 in parallel to bleed capacitor C5 down after power has been removed from the circuit to avoid capacitor C5 from retaining a charge possibly discharging accidentally several seconds after the user releases the trigger. When the voltage in capacitor C5 breaks down spark gap JP1 and when the high voltage connectors J4 and J5 are in contact with an animal, the energy in capacitor C5 discharges through the animal administering the shock. A discharge may also occur when the voltage in capacitor C5 breaks down spark gap JP1 and when a path such as a carbon track is provided between connectors J4 and J5. To reduce and/or eliminate the possibility of a carbon track developing, an insulator manufactured of polypropylene, which resists carbon track build up, supports connectors J4 and J5.

In addition to providing the high voltage, transformer T1 also provides isolation between the power source connected to the primary circuit and the secondary winding connected to the high voltage circuit. The isolation is different from existing stock prod transformers in that the isolation between primary winding and the secondary winding is higher than high voltage potential delivered. This higher level of isolation between primary and secondary winding creates an insulation barrier such that the user is isolated form the high voltage eliminating the possibility of the user receiving a shock through moisture connecting the user to the supply source or primary circuit.

Referring to FIG. 10, transformer T1 is depicted without windings to better facilitate understanding of the invention. As can be seen the transformer T1 comprises a generally u-shaped core 180 having legs 182 and 184. Starting from the left side of the figure, a primary winding connector 188 can be seen. A primary winding bay 190 and a second primary winging connector 192 and one or more isolation members 194 follow this. As mentioned previously, the transformer of the present invention differs from transformers used in prior art stock prods in that it has two secondary windings rather than one secondary winding. Moreover, the secondary windings are connected to each other in series. Thus, the first of the two secondary windings starts with secondary center tap 202, proceeds to secondary winding bays 200 and 196, and ends up at negative secondary winding connection 198. The second of the two secondary windings starts with the secondary center tap 202, proceeds to a secondary winding bays 204 and 208 and attaches to a positive secondary winding connection 206. With this configuration, the two secondary windings are connected to each other in series, with one end of each winding connected at a center tap 202, which is connected to the transformer core 180. By using two secondary windings in series the voltage potential between the transformer's secondary winding can be halved, relative to the core.

The present invention having thus been described, other modifications, alterations or substitutions may present themselves to those skilled in the art, all of which are within the spirit and scope of the present invention. It is therefore intended that the present invention be limited in scope only by the claims attached below.

What is claimed is:

1. A stock prod comprising:
a body; and,
a power module, said power module comprising an input section operatively connectable to a power supply, and an output section operatively connected to a first electrode and a second electrode, with said first and second electrodes spaced apart from each other by a distance sufficient to prevent an electrical discharge therebetween;
wherein the power module is configured and arranged to control, in a predetermined manner, an electrical discharge between the first and second electrodes when the distance between the first and second electrodes has been effectively reduced to the point where it is no longer sufficient to prevent an electrical discharge therebetween.

2. The stock prod of claim 1, wherein the predetermined electrical discharge is non-continuous.

3. The stock prod of claim 1, wherein the predetermined electrical discharge comprises a train of pulses.

4. The stock prod of claim 1, wherein the predetermined electrical discharge comprises a plurality of trains of pulses.

5. A stock prod comprising:
a body; and,
a power module, said power module comprising an input section operatively connectable to a power supply; and an output section operatively connected to a first electrode and a second electrode, with said first and second electrodes spaced apart from each other by a distance sufficient to prevent an electrical discharge therebetween;
wherein the power module is configured and arranged to vary the output between the first and second electrodes.

6. A stock prod comprising:
a body;
a power module, with said power module comprising an input section operatively connectable to a power supply, and an output section operatively connected to a first electrode and a second electrode;
an annunciator operatively connected said power module; and,
a switch operatively connected to said annunciator and to said power module, said switch positionable to complete a first circuit and positionable to complete a second circuit;
wherein the annunciator may be actuated when the switch is positioned to complete the first circuit, and wherein the annunciator and the power module may be actuated when the switch is positioned to complete the second circuit.

7. The stock prod of claim 6, wherein said switch projects outwardly from said body of said stock prod.

8. The stock prod of claim 6, wherein said switch is removably attached to said body of said stock prod.

9. The stock prod of claim 6, wherein said switch further comprises a locking member movably attached thereto, wherein said locking member may be manipulated to prevent said switch from completing either the first or second circuits.

10. A stock prod comprising:
a body;
a power module, with said power module having an input section operatively connectable to a power supply, said power module configured to monitor the operational characteristics of said power supply and compare them to a set of predetermined values; and,
an indicator, said indicator operatively connected to said power module; wherein the indicator is activated by the power module in response to differences between the operational characteristics of the power supply and the set of predetermined values.

11. The stock prod of claim 10, wherein the indicator is visually discernable.

12. The stock prod of claim 10, wherein the indicator comprises a light-emitting-diode (LED).

13. The stock prod of claim 10, wherein said indicator is configured to emit a plurality discernable colors of light.

14. A stock prod comprising:
an elongated body, said elongated body having a longitudinal axis, a first end and a second end; and,
a power supply housing having a first end and a second end, said housing configured to receive and retain at least one battery, with said housing removably attachable to said body and configured to support said stock prod in a generally vertical, free-standing relation.

15. The stock prod of claim 14, wherein said power supply housing is in substantial alignment with the longitudinal axis of said elongated body.

16. The stock prod of claim 14, wherein said second end of said power supply housing is substantially planar.

17. The stock prod of claim 14, wherein said electrical power supply further comprises a battery housing cover, said battery housing cover removably attachable adjacent said first end of said housing.

18. A stock prod comprising:
a body; and,
a power module, with said power module comprising an input section operatively connectable to a power supply, and an output section operatively connected to a first electrode and a second electrode;
wherein said power module configured to monitor the operational characteristics of said power supply and regulate electrical energy supplied to said first and second electrodes of said output section.

19. The stock prod of claim 18, wherein said power module further comprises a micro-controller.

20. A stock prod comprising:
a body; and,
a power module, said power module comprising: an input section operatively connectable to a power supply; a transformer, with said transformer comprising a core, a primary winding and two secondary windings; and, an output section operatively connected to a first electrode and a second electrode.

21. The stock prod of claim 20, wherein said secondary windings are connected to each other in series.

22. The stock prod of claim 20, wherein said secondary windings are connected to the core of the transformer.

23. A stock prod comprising:
a body; and,
a power module, with said power module having an input section operatively connectable to a power supply, and an output section having an end cap, with said end cap configured to retain and position a first electrode and a second electrode in a predetermined spaced apart relation by a distance sufficient to prevent an accidental electrical discharge therebetween, with said end cap comprising material that is resists carbon trail deposition that occurs when an electrical discharge passes between the first and the second electrodes.

24. The stock prod of claim 23, wherein the material of said end cap is polypropylene.

25. A stock prod comprising:
a body; and,
a power module, with said power module comprising an input section operatively connectable to a power supply, and an output section operatively connected to a first electrode and a second electrode;
wherein said power module provides isolation between said input section and said output section wherein said isolation is higher than the potential provided to said output section.
